(19) United States
(12) Patent Application Publication
(10) Pub. No.: US 2006/0006921 A1
(43) Pub. Date: Jan. 12, 2006

(54) Mixer

(76) Inventors: Bernard M. Tenbroek, West Malling (GB); David J. McLaurin, Durham, NC (US); Jonathan R. Strange, Reigate (GB)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/885,159

(22) Filed: Jul. 6, 2004

(51) Int. Cl. G06F 7/44

(52) U.S. Cl. 327/359

(57) ABSTRACT

A mixer core is provided which has a pair of CMOS transistors 21 and 22 connected as a matched pair and having a common source node N₁. The CMOS transistors have a non-linear parasitic capacitance which degrades the harmonic performance of the mixer core. An inductor is connected to the common source node and optionally to ground, a signal input node or to a further common source node when the mixer core is part of a double balanced mixer. The inductor is chosen such that it co-operates with the parasitic capacitors to form a resonant circuit tuned to the local oscillator frequency or optionally a harmonic of it, such as the second harmonic, or to the input signal frequency.

### TECHNICAL FIELD OF THE INVENTION

The present invention relates to a mixer. Such a mixer is suitable for use within a radio or telecommunications system.

### BACKGROUND OF THE INVENTION

It is well known within the radio and telecommunications industries to change the frequency of a signal by mixing it with a signal derived from a local oscillator: This mixing is used at transmission to up convert a signal from a base band frequency to a transmission band, and at reception to down convert a received signal back to the base band frequency, or to an intermediate frequency.

A popular approach to implementing high performance mixers is to convert the signal to the current domain using a transconductor and to implement the frequency translation by switching this current signal with a commutating switch driven by the local oscillator. A well known implementation of this design is the “Gilbert cell”.

### SUMMARY OF INVENTION

According to a first aspect of the present invention there is provided a mixer comprising: a first input; a second input; a first field effect transistor having a gate, a source and a drain; and a first inductor; wherein the first input is provided to the gate of the first field effect transistor, the second input is provided to the source of the first field effect transistor via a first inductor and the first output is connected to the drain of the first field effect transistor, and the first inductor is selected such that it forms a resonant circuit with parasitic capacitors associated with the first field effect transistor.

The inventor has realised that the performance of the mixer is effected by non-linearities within a switching core formed by the first field effect transistor, and any other transistors within the switching core. For a CMOS implementation of a current commutating mixer the linearity of the switching core at higher frequencies is dominated by the non-linear gate-source and source-body capacitances of the or each field effect transistor. Of course, the linearity of the complete mixer design is also determined by the linearity of the transconductor stage and, to a lesser extent, the output network. However for mixers operating with a relatively high local oscillator frequency the linearity of the switching core is often a significant limitation on the overall mixer linearity.

The inventor has realised that the linearity of the switching core at high frequencies can be improved significantly if the impedance at the source node of the field effect transistor is changed such that it is influenced to a lesser extent by the non-linear capacitances presented by the switching core. To avoid a noise and conversion gain penalty, and to gain useful mixer dynamic range, the inventor has realised that the impedance of the source node needs to be increased rather than decreased. This is achieved by the addition of the inductor to the source node, the inductor being sized to form a tuned circuit with the total capacitance on the source node and being nominally tuned to a predetermined frequency.

Preferably, in the context of an up-converter, the inductor is sized such that it combines with the parasitic capacitances to form a resonant circuit tuned to the local oscillator frequency or a harmonic thereof.

Preferably the mixer is a balanced mixer. The symmetric nature of balanced mixers enables them to deliver enhanced performance with regards to distortion/non-linearity when compared to single ended mixers.

Preferably the first input is a differential input, the second input has two input connections (which for convenience may be called first and second input nodes of the second input) and the output has two output connections. This gives rise to a mixer which is balanced with respect to its output and with respect to both its inputs, and such a mixer is often referred to as “a double balanced mixer”.

Preferably the mixer has a second field effect transistor therein having a source, a drain, and a gate.

Advantageously the first and second field effect transistors form a mirrored pair of transistors. Thus the source of the second field effect transistor is connected to the source of the first field effect transistor. However in order to form a mirrored pair the first and second field effect transistors need dissimilar inputs and hence the gate of the first field effect transistor is connected to a first input connection of the first input, whereas the gate of the second field effect transistor is connected to the second input connection of the first input.

Preferably the first input connection is arranged to receive a signal from a local oscillator. Advantageously the first and second field effect transistors are driven to act as switches. Thus, in a first half cycle of the local oscillator signal the first field effect transistor is switched hard on whereas the second field effect transistor is held switched off, and in the second half cycle of the local oscillator signal the first field effect transistor is switched off and the second field effect transistor is switched hard on.

Preferably the drain of the first effect transistor is connected to a first output node, whereas the drain of the second field effect transistor is connected to a second output node.

Advantageously third and fourth field effect transistors are provided and are connected such that the sources of the third and fourth field effect transistors are connected to a second input node of the second input, whereas the sources of the first and second transistors are connected to a first input node of the second input. Advantageously the gate of the third field effect transistor is connected to the gate of the second field effect transistor and the gate of the fourth field effect transistor is connected to the gate of the first field effect transistor. Furthermore, the drain of the first field effect transistor is connected to the first output node, whereas the drain of the fourth field effect transistor is connected to the second output node.

In a first embodiment of the present invention a first inductor is connected in series with the first input node of the second input and a further inductor is connected in series with the second input node of the second input. In this arrangement the first and second inductors are placed in series between the respective transconductors and the switching cores. This arrangement is particularly suitable for use as an up-converter.

Preferably the second input is arranged such that each of the first and second input nodes of the second input receives a substantially equal DC bias current upon which is superimposed an AC signal. The AC signal is differential such that when the first input node of the second input has an input current
I₁=bias current+Δ_{AC}
then the second input node of the second input has an input
I₂=bias current−Δ_{AC}

According to a second aspect of the present invention there is provided a communications system incorporating a mixer constituting an embodiment of the first aspect of the present invention.

According to a third aspect of the present invention there is provided a mixer comprising: a first input; a second input; a first field effect transistor having a gate, a source and a drain; and a first inductor; wherein the first input is provided to the gate of the first field effect transistor, the second input is provided to the source of the first field effect transistor and the first output is connected to the drain of the first field effect transistor, and the inductor is connected between the second input and a further node, and the first inductor is selected such that it forms a resonant circuit with parasitic capacitors associated with the first field effect transistor.

In a second embodiment of a double balanced mixer constituting an embodiment of the present invention the inductor is connected between the first input node of the second input and between the second input node of the second input. This arrangement is particularly suitable for use in a down-converter.

### BRIEF DESCRIPTION OF THE DRAWINGS

The present invention will further be described, by way of example, with reference to the accompanying drawings, in which:

FIG. 1 schematically illustrates a up-conversion mixer constituting an embodiment of the present invention;

FIG. 2 schematically illustrates a down-conversion mixer constituting an embodiment of the present invention; and

FIG. 3 is a graph showing the input referred third harmonic intercept point of a mixer as shown in FIG. 2 with an equivalent Gilbert cell mixer as a function of frequency.

### DESCRIPTION OF PREFERRED EMBODIMENTS

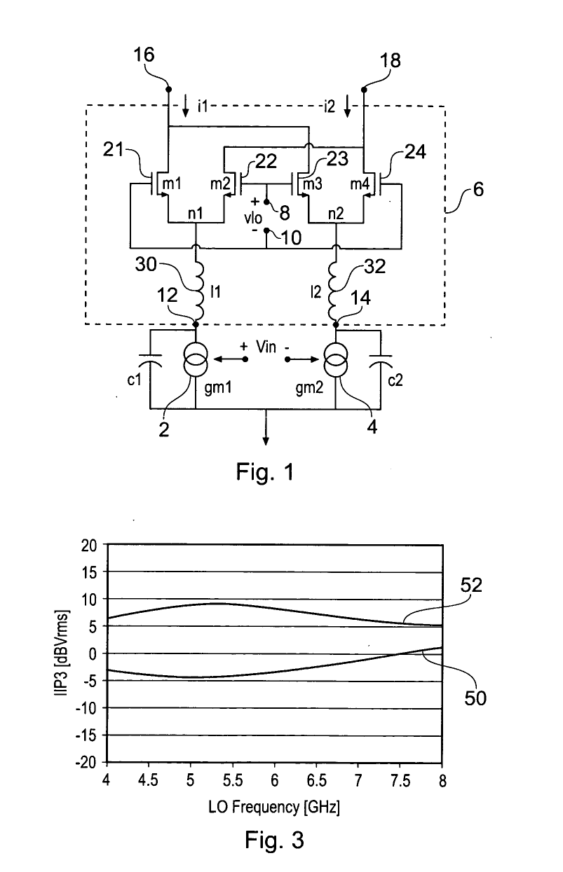

FIG. 1 schematically illustrates the circuit diagram of a mixer constituting an embodiment of the present invention. The circuit topology is similar to that of a Gilbert cell mixer but owing to the inventive insight of the inventors, the performance of this mixer is much improved compared to that of a standard Gilbert cell.

As noted hereinbefore, the Gilbert cell is an example of a commutating mixer and an input signal having a voltage V_{IN} is converted into the current domain by transconductance amplifiers 2 and 4 which are devices well known to the person skilled in the art and need not be described in detail here. The present invention relates to the improvement of the performance of the switching core of the mixer and, in the arrangement shown in FIG. 1, the components within the switching core are enclosed within the broken outline 6. The switching core in this example is double balanced and hence has first and second local oscillator input nodes 8 and 10, first and second signal input nodes 12 and 14, and first and second output nodes 16 and 18, respectively. The local oscillator inputs 8 and 10 can be regarded as a first input, whereas the signal inputs 12 and 14 can be regarded as a second input.

First to fourth CMOS field effect transistors 21, 22, 23 and 24, respectively, are provided within the switching core. The first and second transistors 21 and 22 form a mirror pair. Similarly the third and fourth transistors 23 and 24 also form a mirror pair. Each of the transistors has a source, a drain and a gate. The sources of the first and second transistors 21 and 22 are connected together at a first node N₁ which is itself connected to the first signal input node 12 via a first inductor 30. The gate of the second transistor 22 is connected to the first input 8 of the local oscillator input, whereas the gate of the first transistor 21 is connected to the second input 10 of the local oscillator input. Thus the first and second transistors 21 and 22 are driven in anti-phase by a local oscillator signal supplied to the local oscillator inputs 8 and 10 by a local oscillator (not shown). The drain of the first transistor 21 is connected to the first output node 16 whereas the drain of the second transistor 22 is connected to the second output node 18. A functioning balanced active CMOS mixer could be adequately implemented using only transistors 21 and 22 as hereinbefore described. However, in the case of a double balance mixer transistors 23 and 24 form a second mirrored pair with the sources of the transistors 23 and 24 connected to a second node N₂ which itself is connected to the second input node 14 of the signal input via a second inductor 32. The gate of the third transistor 23 connected to the gate of the second transistor 22 and the gate of the fourth transistor 24 is connected to the gate of the first transistor 21. The drain of the third transistor 23 is connected to the first output node 16 whereas the drain of the second transistor 24 is connected to the second output node 18. Each of the pairs of transistors is biased on by a DC bias provided by the transconductance amplifiers 2 and 4. The DC bias supplied to each pair is nominally identical but an AC signal representative of the input signal which is to be mixed with the local oscillator signal is superimposed in a differential fashion on the DC biases such that if the current flowing through the first transconductance amplifier 2 is increased by a specific amount Δ₁ due to the input signal V_{IN}, then the current provided by the second transconductance amplifier 4 is reduced by a corresponding amount Δ₁.

Each of the transistors 21, 22, 23 and 24 is a real component and hence its performance deviates from the ideal. Each of the transistors 21 to 24 has associated with it a parasitic capacitance between the gate and the source electrodes and also a parasitic capacitance between the transistor as a whole and the substrate upon which it is formed. In simplistic terms, the parasitic capacitance within each field effect transistor can be regarded as having two plates. One of these plates is the physical plate of the gate electrode, whereas the other plate can be regarded as related to the position of the conductive region within the channel of the field effect transistor. The “position” of this second “plate” varies depending upon the conducting state of the transistor and hence the parasitic capacitance of the CMOS transistors 21 to 24 is non-linear. This non-linearity gives rise to the introduction of higher order harmonics within the mixer output. These are undesirable

Somewhat surprisingly, the disadvantageous consequences of the non-linear parasitic capacitors can be significantly reduced by the provision of at least one inductor which co-operates with parasitic capacitances to form a tuned circuit. The inductors 30 and 32 are selected such that they co-operate with the parasitic capacitors, as will be described later, to resonate at a selected frequency.

Capacitors C₁ and C₂ are provided in parallel with the transconductance amplifiers 2 and 4 to ensure that the impedance at the output nodes (nodes 12 and 14 as shown in FIG. 1) is low at the local oscillator frequency. Hence the impendence at the common source nodes N₁ and N₂ can be relatively large. However, seen from the transconductance amplifier outputs the topology shown in FIG. 1 shows a low pass filter response. For this reason the series resonator topology is more suitable for applications where the input frequency is relatively low, i.e. as an up-converter. The mixer shown in FIG. 1 is particularly suited for direct conversion transmit architectures.

The centre frequency of the band pass response created at the common source nodes N₁ and N₂ can be independent from the pole of the low pass filter of the output of each of the transconductance amplifiers 2 and 4. As a consequence the designer has freedom to tune the common source nodes to frequencies other than the local oscillator frequency. Since the wave form observed on the common source nodes N₁ and N₂ of the mixer shown in FIG. 1 typically exhibits a strong second harmonic component then the designer may, if he so wishes, choose to tune the resonator circuit formed by the parasitic capacitances of the transistors 21 and 22, and the inductor 30 to the second harmonic The same tuning is, of course, done with regard to the transistors 23 and 24 and the inductor 32.

The resonator topology as shown in FIG. 1 can be applied to a single balanced current communicating mixer with a single ended transconductor (components 23, 24, 42, 4 and C₂ of FIG. 1 are omitted in this configuration) or to quadrature mixers which can either be single or double balanced.

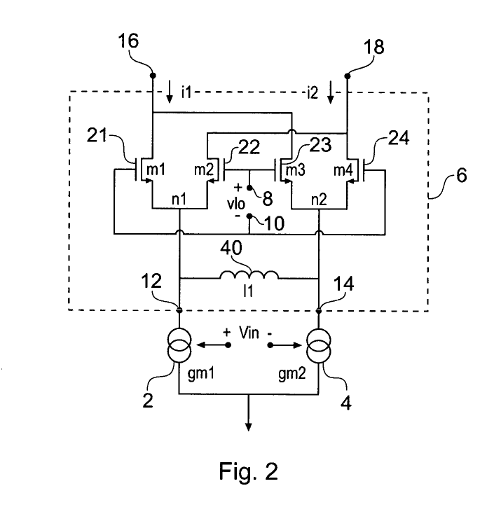

FIG. 2 shows an alternative embodiment which is suited for use as a down-converter. The inductors 30 and 32 extending between the node N₁ and the first transconductance amplifier 2, and the second inductor extending between the node N₂ and the second transconductance amplifier 4, are replaced by direct connections. A first inductor 40 is interposed between the node N₁ and the node N₂.

The inductor 40 is, in this example, shown as interconnecting the node N₁ to the node N₂ but a similar performance can be achieved by providing two separate inductors, one inductor extending from the node N₁ to ground or a bias voltage, and the second inductor extending from the node N₂ to ground. The second configuration (inductor extending from the node N₁ to ground) would be used for a single balanced mixer in which the transistors 23 and 24 and the input node 14 where omitted.

Generally, the inductor 40 is selected such that in combination with the parasitic capacitors, it has a resonant frequency corresponding to that of the input signal. However, it may observed that the waveform at the common source nodes N₁ and N₂ exhibits a strong second harmonic component in which case it may be beneficial for linearity performance to tune the common source inductor 40 such that the resonant circuit formed by it and the parasitic capacitors resonates at the second harmonic frequency.

When the resonant tank circuit is tuned to the input signal frequency the mixer is suited for direct conversion or low intermediate frequency receiver architectures. It can also be used as a down conversion mixer with higher output frequencies but with some degradation in the conversion gain and input referred noise. Alternatively the tank circuit comprising the inductor 40 and the parasitic capacitors may be tuned to the second harmonic component of the local oscillator frequency providing a mixer suited for use as a down-converter for applications with an input frequency approximately twice the local oscillator frequency.

FIG. 3 is a graph showing the improvement obtained in the mixer shown in FIG. 2 by including the inductor 40 compared to the performance of the identical mixer but with the inductor omitted. The ordinate of FIG. 3 shows the input referred third harmonic intercept point (which is a frequently used and standard measurement of non-linearity within the radio frequency engineering community). The line designated 50 shows the performance of the mixer with respect to frequency in the absence of the inductor 40, whereas the line designated 52 shows the performance of the mixer in the presence of the inductor 40, when, in this example, it has been tuned to 5.2 GHz. At between 5 and 5.5 GHz the intercept point is improved from −5 dBVrms to approximately +8 dBVrms. This constitutes a significant improvement in non-linearity or alternatively this can be regarded as an improvement or an extension in the dynamic range by virtue of an effective reduction in the noise floor.

It is thus possible to provide significant performance improvements in CMOS implemented mixers by the inclusion of one or more additional components which cause the parasitic capacitances of the CMOS transistors to be absorbed within a resonant circuit. The additional components, such as inductors, do not themselves have to be high quality components, and can be quite lossy whilst still enhancing circuit performance.

1. A mixer comprising:
a first input;
a second input;
a first field effect transistor having a gate, a source and a drain; and
a first inductor;
wherein the first input is provided to the gate of the first field effect transistor, the second input is provided to the source of the first field effect transistor via a first inductor and the first output is connected to the drain of the first field effect transistor, and the first inductor is selected such that it forms a resonant circuit with parasitic capacitors associated with the first field effect transistor.

2. A mixer as claimed in claim 1, in which the first input is, in use, arranged to receive a local oscillator signal from a local oscillator so as to cause the first field effect transistor to switch on and off in response to the local oscillator signal.

3. A mixer as claimed in claim 2, in which the resonant circuit is arranged to resonate at a harmonic of the local oscillator signal.

4. A mixer as claimed in claim 3, in which the resonant circuit is arranged to resonate at the second harmonic of the local oscillator signal.

5. A mixer as claimed in claim 1, wherein the first input has first and second input connections and further comprising a second field effect transistor having a gate, a source and a drain, and the mixer has a second output, and wherein the source of the second field effect transistor is connected to the source of the first field effect transistor forming a first common source node, and drain of the second field effect transistor is connected to the second output and the gate of the second transistor is connected to the second input connection of the first input.

6. A mixer as claimed in claim 5, wherein the first input comprises a first local oscillator input node and a second local oscillator input node and the gate of the first field effect transistor is connected to the first local oscillator input node to the gate of the second field effect transistor is connected to the second local oscillator input node.

7. A mixer as claimed in claim 6, further comprising a third field effect transistor and a fourth field effect transistor, each having a gate, a source and a drain, and wherein:
the sources of the third and fourth field effect transistors are connected together forming a second common source node;
the gate of the third transistor is connected to the gate of the second transistor;
the drain of the third transistor is connected to the first output;
the gate of the fourth transistor is connected to the gate of the first transistor,
the drain of the fourth transistor is connected to the second output; and
the second common source node is connected to a further second input node via a second inductor.

8. A mixer as claimed in claim 1, in which the second input is, in use, connected to a current source which is varied in accordance with a signal supplied thereto.

9. A mixer as claimed in claim 7, in which the second input is a signal input having a first signal input node connected to the first common source node via the first inductor and a second signal input node connected to the second common source node via the second inductor and, in use, the first and second signal inputs are driven by transconductance devices which transform an input voltage signal into a current.

10. A mixer as claimed in claim 8, further including an in-phase channel and a quadrature channel.

11. A mixer as claimed in claim 1, fabricated within a monolithic integrated circuit.

12. A mixer core comprising a Gilbert cell in combination with an inductor connected in series with a signal input of the Gilbert cell so as to from a resonant circuit in combination with parasitic capacitances therein, said resonant circuit tuned to resonate at one of a fundamental and a harmonic frequency of an oscillator signal supplied to an oscillator input of the Gilbert cell.

13. A mixer comprising:
a first input;
a second input;
a first field effect transistor having a gate, a source and a drain; and
a first inductor;
wherein the first input is provided to the gate of the first field effect transistor, the second input is provided to the source of the first field effect transistor and the first output is connected to the drain of the first field effect transistor, and the inductor is connected between the second input and a further node, and the first inductor is selected such that it forms a resonant circuit with parasitic capacitors associated with the first field effect transistor.

14. A mixer as claimed in claim 13, in which the first input is, in use, arranged to receive a local oscillator signal from a local oscillator so as to cause the first field effect transistor to switch on and off in response to the local oscillator signal.

15. A mixer as claimed in claim 13, in which the resonant circuit is arranged to resonate at substantially the frequency of an input signal supplied to the second input.

16. A mixer as claimed in claim 13, in which the further node is grounded.

17. A mixer as claimed in claim 13, in which the further node is connected to a power supply rail.

18. A mixer as claimed in claim 13, wherein the first input has first and second input connections and further comprising a second field effect transistor having a gate, a source and a drain, and the mixer has a second output, and wherein the source of the second field effect transistor is connected to the source of the first field effect transistor forming a first common source node, and drain of the second field effect transistor is connected to the second output and the gate of the second transistor is connected to the second input connection of the first input.

19. A mixer as claimed in claim 18, wherein the first input comprises a first local oscillator input node and a second local oscillator input node and the gate of the first field effect transistor is connected to the first local oscillator input node to the gate of the second field effect transistor is connected to the second local oscillator input node.

20. A mixer as claimed in claim 18, further comprising a third field effect transistor and a fourth field effect transistor, each having a gate, a source and a drain, and wherein:
the sources of the third and fourth field effect transistors are connected together forming a second common source node;
the gate of the third transistor is connected to the gate of the second transistor;
the drain of the third transistor is connected to the first output;
the gate of the fourth transistor is connected to the gate of the first transistor,
the drain of the fourth transistor is connected to the second output; and
the second common source node is connected to a further second input node directly.

21. A mixer as claimed in claim 20, in which the second input is a signal input and the second input has a first signal input node connected to the first common source node and a second signal input node connected to the second common source node and the first inductor is connected between the first common source node and the second common source node.

22. A mixer as claimed in claim 20, in which the second input is a signal input and the second input has a first signal input node connected to the first common source node and a second signal input node connected to the second common source node, and the first inductor is connected between the first common source node and a ground node or a supply rail; and a second inductor is connected between the second common source node and the ground node or a supply rail.

23. A mixer as claimed in claim 13, in which the second input is, in use, connected to a current source which is varied in accordance with a signal supplied thereto.

24. A mixer as claimed in claim 20, in which the second input is a signal input having a first signal input node connected to the first common source node and a second signal input node connected to the second common source node and, in use, the first and second signal inputs are driven by transconductance devices which transform an input voltage signal into a current.

25. A mixer as claimed in claim 13, fabricated within a monolithic integrated circuit.

26. A communications device including a mixer as claimed in claim 1.

27. A communications device as claimed in claim 13.
